(19) United States
(12) Patent Application Publication
(10) Pub. No.: US 2025/0124930 A1
(43) Pub. Date: Apr. 17, 2025

(54) COMPUTER-BASED PRIVACY FOR A CHAT GROUP IN A VIRTUAL ENVIRONMENT

(71) Applicant: International Business Machines Corporation, Armonk, NY (US)

(72) Inventors: Jun Qian Zhou, Shanghai (CN); Dan Zhang, Shanghai (CN); Yuan Jie Song, Shanghai (CN); Meng Chai, Shanghai (CN); Xiao Feng Ji, Shanghai (CN)

(21) Appl. No.: 18/486,543

(22) Filed: Oct. 13, 2023

(51) Int. Cl. G10L 17/22; G06T 13/20; G06T 13/40; G10L 17/02

(52) U.S. Cl. CPC G10L 17/22; G06T 13/205; G06T 13/40; G10L 17/02

(57) ABSTRACT

In an approach to improve the privacy of chat groups within a virtual world, embodiments of the present invention expand a chat area of a chat group to form an experience annulus according to predetermined distance that a voice volume of private-chat-group member can propagate. Responsive to identifying an external user is interested in the chat group, embodiments generate and set a current topic representing a conversation in the chat group as an externally hearable topic that is perceivable by the external user and generate a faux multi-person conversation associated with the externally hearable topic that corresponds to a real conversation made by members in the chat group. Further, embodiments assign the faux utterances to chat group members based on a corresponding speaker index and utilize one or more corresponding avatars of the chat group members to present the faux utterances to the external user.

### BACKGROUND OF THE INVENTION

The present invention relates generally to virtual reality, and more particularly to the field of improving the privacy and communication in chat groups.

The term chat room, or chatroom (and sometimes group chat), is primarily used to describe any form of synchronous conferencing, occasionally even asynchronous conferencing. The term can thus mean any technology, ranging from real-time online chat and online interaction with strangers (e.g., online forums) to fully immersive graphical social environments. The primary use of a chat room is to share information via text with a group of other users. The ability to converse with multiple people in the same conversation differentiates chat rooms from instant messaging programs, which are more typically designed for one-to-one communication. The users in a particular chat room are generally connected via a shared internet or other similar connection, and chat rooms exist catering for a wide range of subjects. New technology has enabled the use of file sharing and webcams, and virtual interaction using three-dimensional avatars within a virtual world.

### SUMMARY

Embodiments of the present invention disclose a computer-implemented method, computer system, and computer program product for improving privacy and communication within a chat group in a virtual world, the computer-implemented method comprising: expanding a chat area of a chat group to form an experience annulus according to predetermined distance that a voice volume of private-chat-group member can propagate; responsive to identifying an external user is interested in the chat group, generating and setting a current topic representing a conversation in the chat group as an externally hearable topic that is perceivable by the external user; generating an faux multi-person conversation associated with the externally hearable topic that corresponds to a real conversation made by members in the chat group, wherein the faux multi-person conversation is a collection of generated faux utterances that correspond with real utterances from the chat group; assigning the faux utterances to chat group members based on a corresponding speaker index; and utilizing one or more corresponding avatars of the chat group members to present the faux utterances to the external user.

### BRIEF DESCRIPTION OF THE DRAWINGS

FIG. 1 is a functional block diagram illustrating a distributed data processing environment, a program, in accordance with an embodiment of the present invention;

FIG. 2 illustrates a functional block diagram and operational steps of the program, on a server computer within the distributed data processing environment of FIGS. 1, in accordance with an embodiment of the present invention;

FIG. 3 illustrates a functional block diagram and operational steps of the program, on a server computer within the distributed data processing environment of FIGS. 1, in accordance with an embodiment of the present invention;

FIG. 4 illustrates one example, in accordance with an embodiment of the present invention;

FIG. 5 illustrates operational steps of the program, on a server computer within the distributed data processing environment of FIGS. 1, for generating and presenting externally perceivable features associated with a group chat in a virtual environment, in accordance with an embodiment of the present invention; and

FIG. 6 illustrates operational steps of the program, on a server computer within the distributed data processing environment of FIGS. 1, for generating and presenting externally perceivable features associated with a group chat in a virtual environment, in accordance with an embodiment of the present invention.

### DETAILED DESCRIPTION

Embodiments of the present invention recognize that private chat groups in three-dimensional (3D) virtual rooms do not disclose private chat content to users outside the group. Typically, a floating text above a private chat group is used at most to inform external users of the current topic being discussed by the private chat group, which allows external users gauge their interest in joining the chat group. However, embodiments of the present invention recognize that using floating text to inform external users of the current topic does not create a good experience and is not a natural way of knowing the current discussion topic that does not mimic or mirror conversations in the physical world.

Moreover, embodiments of the present invention recognize that before users join private chat groups, due to the opacity of these groups, users are unable determine the overall engagement level of the group, i.e., whether there are many or few utterances taking place, the engagement level of each member within the group, i.e., how many utterances each member has made, and/or understand the progress of the current topic (i.e., how long the current topic will last). Therefore, embodiments of the present invention recognize that after applying and being approved to join a private group, users may find that the group does not talk about topics efficiently, or the current topic that they are interested has ended, which results an unsatisfactory experience for users.

Embodiments of the present invention improve the art of virtual communication and solve the issues stated above by presenting external perceivable features of a private group chat within a virtual world. More specifically, embodiments improve the art of virtual communication and solve the particular issues stated above by (i) expanding chat area of a private chat group to form an experience annulus according to a farthest distance that a maximum voice volume of private-chat-group members can propagate, and increasing a range of the experience annulus dynamically according to a number of new members to be added; (ii) setting a current topic of the private chat group or a randomly generated topic as an external user's externally hearable topic based on the analysis of whether the external user is interested in the current topic; (iii) generating a faux multi-person conversation about the externally hearable topic, by using large language model, which corresponds to a real conversation made by the private chat group, wherein each faux utterance has the same word count, speech speed, language, speaker index as its corresponding real utterance, and wherein the order of speakers uttering all faux utterances in sequence is the same as the real conversation; (iv) assigning each faux utterance, according to speaker index, to a private-chat-group member in sequence, and then use that member's virtual avatar to present the assigned faux utterance to a user in the experience annulus aurally and visually; and (v) generating future multi-person conversations N times based on a historical real conversation, by using large language model, to obtain a chat progress composed of the numbers of historical and generated future utterances. An utterance is construed to be any spoken word, statement, or vocal sound and/or any identified non-verbal communication (e.g., hand gesture, facial expression, or sign language).

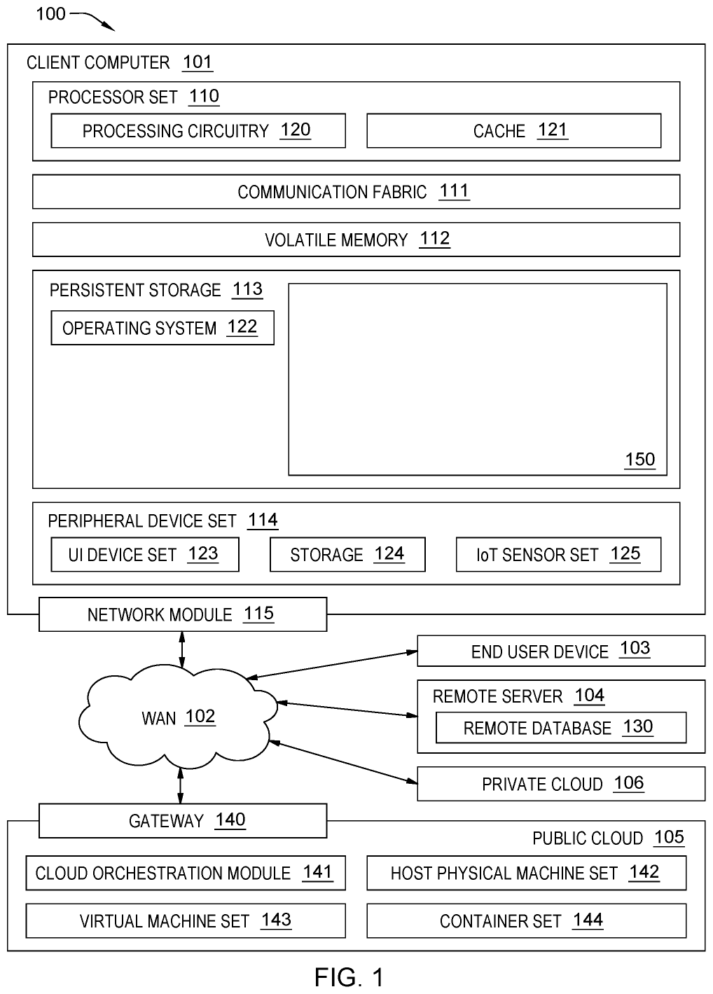

Implementation of embodiments of the invention may take a variety of forms, and exemplary implementation details are discussed subsequently with reference to the Figures (i.e., FIG. 1-FIG. 6).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, a virtual reality headset, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Component 150 may present, via a display in a virtual environment (e.g., floating text above a private chat group), externally perceivable features (i.e., current topic, overall engagement level, engagement level of each member and chat progress) of a private chat group in a 3D virtual chat room. For example, suppose there is a user represented by a virtual avatar standing in an experience annulus, who is not a member of a private chat group yet (i.e., external user) but has expressed interest in becoming a member of the private chat group. In this example, responsive to component 150 identifying the user as being interested in the current topic of the private chat group, component 150 generates a faux conversation based on the current topic that is taking place. Component 150 may output and display the faux conversation and floating text above a private chat group reflecting the faux utterances and the faux topic to the external user. In various embodiments, there is a one-to-one correspondence between the real and faux conversation in terms of number of utterances, word count per utterance, speech speed per utterance, language per utterance, involved speakers and order of utterances. In other embodiments, externally hearable topics (e.g., faux utterances) are not displayed via the floating text above a private chat group. Instead, in other embodiments, the externally hearable topic is filled into the prompt template, and thus the generated faux conversation is emitted as the externally hearable topic. Subsequently, component 150 emits the externally hearable topic to the external user as the hearable topic in the faux conversation (no need to view any floating texts).

In various embodiments, component 150 generates a second utterance that corresponds to a first utterance between a first avatar and a second avatar and outputs the second utterance to a third avatar (e.g., external user), wherein the second utterance is a generative utterance (e.g., a faux sentence that correlates to a real spoke sentence) and the third avatar is not a participant or member of the private conversation between the first avatar and second avatar. In various embodiments, component 150 executes a manipulation of the first avatar and/or the third avatar to match the generated and output second utterance. For example, if a member of the private chat group starts talking, then a faux utterance corresponding to the real speech of the member will be generated and output by the member's virtual avatar, and the user in the experience annulus will be fed via an audio system (e.g., hear) or text to speech system the generated faux sentence instead of the real spoken sentence. Further, in this example, dynamic changes to the lip region (referred to as faux lip changes) and/or facial changes of the member's virtual avatar that are displayed within the field of view of the user's VR glasses will be implemented to match the generated and output faux sentence.

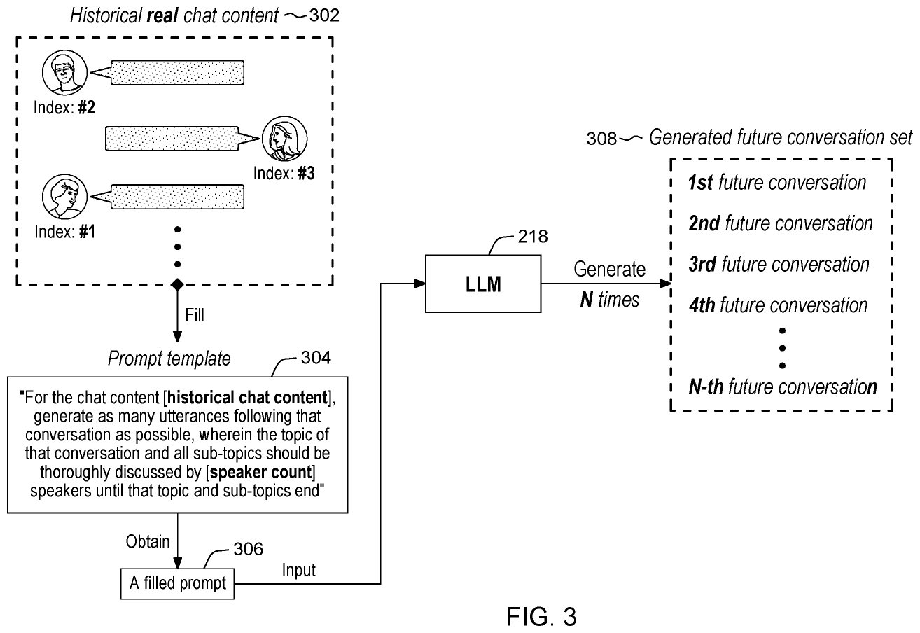

In various embodiments, component 150 predicts the future conversation of a current topic that will likely be made by the private chat group to obtain the number of future utterances included in that predicted conversation. As further described in FIG. 3 below, the historical real multi-person conversation is tracked and recorded automatically, wherein each verbal utterance is converted to text utterance via speech-to-text. In various embodiments, responsive to the recorded historical text utterances (in the recorded order) being filled into the prompt template (depicted in FIG. 3 below) to obtain a prompt, component 150 inputs the prompt into a large language model (LLM) to generate one or more future conversations that follows and/or relates to the historical conversation taken place in the private chat group.

For example, a historical conversation between three friends, John, Rose, and Lisa, in a private chat group, associated with planning a trip to Seattle comprises the following conversation:

John: Hello everyone! I recently read some travel guides about Seattle, and it seems really interesting there. What do you think about the three of us going to Seattle for a trip?
Rose: Wow, that sounds great! I've always wanted to see the Space Needle in Seattle. Lisa, what do you think?
Lisa: I've also heard that Seattle is a beautiful city. It will be fun for the three of us to go together. We should plan ahead so that we can have even more fun.
John: I totally agree. We can visit museums, art galleries, and those famous coffee shops.
Rose: Yes, I've heard that Seattle's coffee culture is particularly famous. We must go and taste it. Also, if time allows, we can visit Pike Market. The seafood there is said to be very fresh.

In this example, the prompt template is defined to be “For the chat content [historical chat content], generate as many utterances following that conversation as possible, wherein the topic of that conversation and all sub-topics should be thoroughly discussed by [speaker count] speakers until that topic and sub-topics end.” Meaning, in this example, component 150 will fill in the historical chat content between John, Rose, and Lisa, shown above, and insert a speaker count “3” into the prompt template to produce a prompt. In various embodiments, component 150 feeds the prompt into an LLM, wherein the LLM generates, and outputs future chat content associated with the private chat group. Continuing the example with John, Rose, and Lisa, the generated future chat content generated by the LLM is as follows:

Lisa: I'm glad you mentioned Pike Market, Rose. They say the fishmongers there put on a show throwing fish! I've seen videos of it, and it looks like a fun experience.
John: Yeah, I've heard about that too! Also, we shouldn't miss the chance to take a ferry ride. The views of the city and the surrounding mountains are supposed to be breathtaking.
Rose: Speaking of mountains, maybe we can take a day trip to Mount Rainier. The hiking trails are supposed to be incredible.
Lisa: That sounds adventurous! And since we're talking about nature, the Washington Park Arboretum is supposed to be stunning, especially in the spring.
John: I'm also interested in the tech scene in Seattle. Maybe we can take a tour of some big tech company campuses like Microsoft or Amazon?
Rose: Good idea! And on the cultural side, how about catching a live music performance? Seattle's music scene is legendary.
Lisa: Absolutely, I'd love to explore the city's grunge roots. And if we're into art, we must visit the Museum of Pop Culture.
John: Speaking of museums, we could also check out the Museum of Flight. I've heard it's a must-see for aviation enthusiasts.
Rose: And let's not forget about food! Besides seafood, Seattle is famous for its diverse cuisine. We must try some local dishes.
Lisa: Yes, and we should consider taking a cooking class or food tour. It would be a great way to learn more about the local culture.
John: I like that idea! And since we're on the topic of learning, we should also check out the universities. The University of Washington campus is supposed to be beautiful.
Rose: This trip is shaping up to be really exciting. I think we should create a detailed itinerary to make sure we don't miss anything.
Lisa: I agree, Rose. Let's also consider the weather, as Seattle's weather can be unpredictable. We should pack accordingly.
John: Good point, Lisa. I'll look into hotel and transportation options, so we have everything planned out.
Rose: Fantastic! It's settled then. This will be an amazing trip, exploring everything Seattle has to offer.
Lisa: Agreed! We've covered everything from landmarks and nature to culture, tech, food, and logistics. Let's get started on the planning.
John: Definitely. Seattle, here we come!

For the current topic, component 150 may define the ratio of historical-utterance number to future-utterance number as chat progress. Component 150 may identify and utilize a predetermined borderline between a chat area and a related experience annulus to generate and display a visual indicator to a user, wherein component 150 may color code the borderline. For example, component 150 identifies the borderline between a chat area and a related experience annulus, and colors the borderline with red and green colors (red indicating historical-utterance number and green indicating future-utterance number) in the same proportion as chat progress, so that a user can visually identify how long a current topic will be discussed. In various embodiments, a chat area is defined as a minimum enclosed area containing only the locations of the members of a private chat group, wherein the enclosed area is a predefined space. Component 150 may expand an invisible ring area (called “experience annulus”) outside a chat area.

In various embodiments, component 150 utilizes the experience annulus to provide externally perceivable features of a private chat group to a non-chat group user (e.g., external user) who is interested in the current topic. For example, the externally perceivable features of a private chat group generated and displayed to an external user comprise: (i) the current topic, (ii) the overall engagement level of the current topic measured by the total number of utterances per unit time, (iii) which members in the private chat group are talking about the current topic, and who is the most active speaker on the current topic, and/or (iv) the chat progress of the current topic. In various embodiments, component 150 displays the perceivable features in a virtual world so that a user (e.g., an external user) can view them using a corresponding virtual reality headset or an augmented reality enabled device that enables the user to view the virtual displayed perceivable features.

Component 150 improves the art and provides advantages over the current art through the external perceivable features and utilization of the experience annulus. For example, the externally perceivable features provide more helpful information for external users before they request to join a private chat group and improve the whole user experience and the process of applying to join private chat groups, without exposing the real conversation of private chat groups. Further, in another example, externally perceivable features open the possibility for external users to discover active members of a private chat group and add them as one-on-one chat participants, and/or the experience annuluses enable a 3D virtual chat room containing plurality of private chat groups contain more auditory content, which improves the sense of immersion of the 3D virtual chat room, rather than facilitating a quiet room.

In various embodiments, component 150 improves the art of virtual communication and solve the particular issues stated above by (i) expanding chat area of a private chat group to form an experience annulus according to a farthest distance that a maximum voice volume of private-chat-group members can propagate, and increasing a range of the experience annulus dynamically according to a number of new members to be added; (ii) setting a current topic of the private chat group or a randomly generated topic as an external user's externally hearable topic based on the analysis of whether the external user is interested in the current topic; (iii) generating a faux multi-person conversation about the externally hearable topic, by using large language model, which corresponds to a real conversation made by the private chat group, wherein each faux utterance has the same word count, speech speed, language, speaker index as its corresponding real utterance, and wherein the order of speakers uttering all faux utterances in sequence is the same as the real conversation; (iv) assigning each faux utterance, according to speaker index, to a private-chat-group member in sequence, and then use that member's virtual avatar to present the assigned faux utterance to a user in the experience annulus aurally and visually; and (v) generating future multi-person conversations N times based on a historical real conversation, by using large language model, to obtain a chat progress composed of the numbers of historical and generated future utterances.

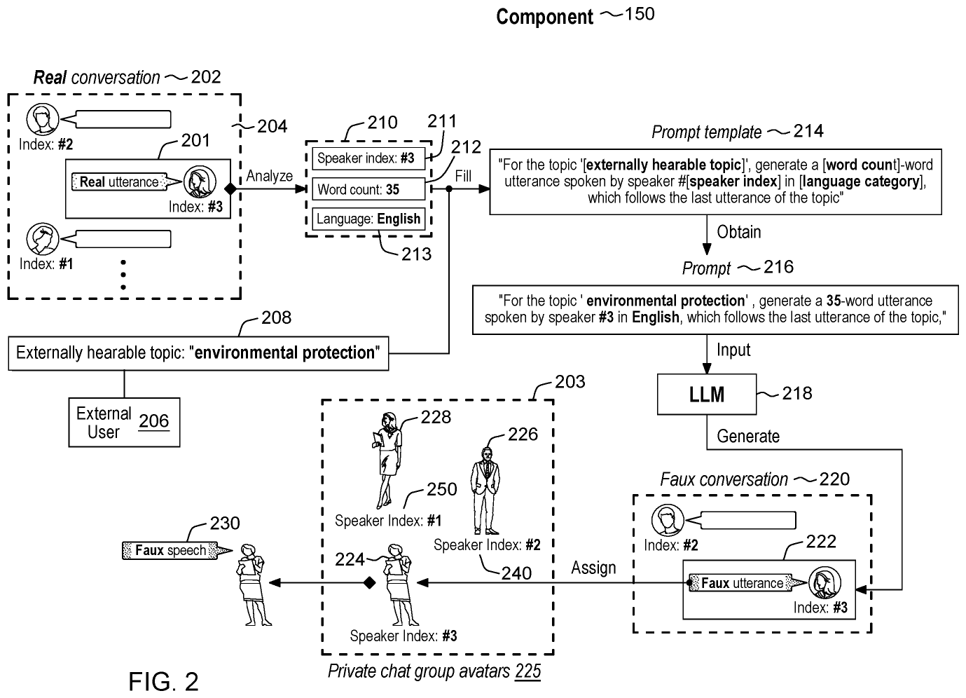

FIG. 2 is a functional block diagram illustrating a distributed data processing environment in accordance with one embodiment of the present invention. The term “distributed” as used in this specification describes a computer system that includes multiple, physically distinct devices that operate together as a single computer system. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. The distributed data processing environment may include client computer 101, and remote server 104 interconnected via WAN 102.

In the depicted embodiment, component 150 monitors and tracks, in real time, conversation 204 (may also be referred to as real conversation) of private chat group (chat group) 202. In various embodiments, component 150 may track at least a portion of conversation 204 in real time and identify and extract the number of utterances, and order of utterances and speaker index 211 of each utterance, wherein each identified verbal utterance is converted to text via a speech-to-text system. In various embodiments, component 150 utilizes the converted text from the verbal utterances to analyze and determine current topics, word count per utterance, speech speed per utterance (slow/normal/fast), and language per utterance. Component 150 may record and store the captured date from the monitored and tracked conversation 204 to a database (not depicted in FIG. 2).

In the depicted embodiment, component 150 identifies whether the current topic being discussed in chat group 202 is of interest to external user 206 (i.e., a user who is not a member of chat group 202) based on an analysis of the historic activities, user profile, designated liked topics, and/or any other user data of external user 206. In various embodiments, responsive to identifying external user 206 is interested in the current topic of chat group 202, component 150 generates and outputs an utterance that is externally perceivable to external user 206. For example, in the depicted embodiment, component 150 outputs externally hearable topic 208 to external user 206 that is associated with conversation 204. In this example, externally hearable topic 208 is the topic ‘environmental protection’. In various embodiments, if component 150 identifies that external user is not interested in conversation 204 or that chat group 202 is no longer accepting new group members then component 150 randomly generates an alternative topic unrelated to conversation 204 (e.g., faux topic) and outputs the randomly generated alternative topic to external user 206 as externally hearable topic 208. In some embodiments, component 150 utilizes the user data associated with external user to identify a topic that external user 206 is uninterested to facilitate the alternative topic that is output to external user 206.

In the depicted embodiment, for each utterance of conversation 204 based on the recorded order of each utterance in conversation 204, component 150 utilizes recorded speaker index 211, word count 212, language 213 from recorded conversation data 210 and externally hearable topic 208 to fill prompt template 214. Prompt template 214 is utilized to generate and output prompt 216. For example, recorded conversation data 210 comprises speaker index 211, word count 212, and language 213, wherein speaker index 211 comprises index #3, component 150 has identified word count 212 of speaker index 211 to be 35 words, and component 150 has identified language 213 of speaker index 211 to be English. Continuing the example in the depicted embodiment, prompt template 214 comprises four template parameters (surrounded by square brackets, e.g., “[externally hearable topic]”), which will respectively be filled by: (a) externally hearable topic 208 as the topic; (b) word count 212 reflective of an utterance spoken by a speaker (i.e., chat group member); (c) speaker index 211 (e.g., speaker index #3) of the speaker; (d) language 213 (e.g., English) used to speak the utterance. In various embodiments, component 150 fills prompt template 214 with the template parameters. For example, in the depicted embodiment, prompt template 214 is filled as follows: “For the topic ‘[externally hearable topic]’, generate a [word count]-word utterance spoken by speaker number (#[speaker index]) in [language category], which follows the last utterance of the topic.” In various embodiments, the template parameters comprise of a plurality of parameters that are predetermined.

Speaker index may correspond to a user identification number, or a numerical metric used to index and catalog utterances of a user within a conversation with other users. In the depicted example, speaker index #1 corresponds to an utterance from a first user, speaker index #2 corresponds to an utterance from a second user, and speaker index #3 corresponds to an utterance from a third user. In various embodiments, the speaker index may be used to identify and distinguish users (e.g., user one is speaker index #1, user two is speaker index #2, user three is speaker index #3, and user N is speaker index #N, wherein N is any positive integer).

In the depicted embodiment, component 150 feeds prompt 216 into large language model (LLM) 218 to generate faux utterance 222 to simulate faux conversation 220, wherein faux utterance 222 corresponds to a real utterance from conversation 204 (e.g., real utterance 201). In various embodiments, faux utterance 222 is associated with externally hearable topic 208 and has the same word count, language, and speaker index as corresponding real utterance 201. In various embodiments, faux conversation 220 is composed of a plurality of faux utterances that are generated in sequence that correspond to a plurality of real utterances in conversation 204. In some embodiments, the corresponding faux utterances equal the same number of real utterances. Therefore, in various embodiments, faux conversation 220 and faux utterance 222 are mirror conversations and utterances of conversation 204 and real utterance 201; however, faux conversation 220 and faux utterance 222 cover different discussion topics than those discussed in conversation 204. In various embodiments, component 150 produces a replication where the order of speakers (indicated by speaker indices) uttering the faux utterances in sequence is the same as the corresponding real conversation.

In various embodiments, component 150 assigns faux utterance 222 to a specific member of private chat group 202 based on speaker index 211, wherein faux utterance 222 is assigned to the user whose real utterance 201 utilized to generate faux utterance 222. In various embodiments, members of the private chat group interact through virtual avatars (avatars) and may be display as a group of avatars having a conversation (e.g., private chat group avatars 225). In various embodiments, component 150 assigns a faux utterance associated with a speaker index to an associating avatar in private chat group avatars 225. In the depicted embodiment, component 150 assigns faux utterance associated with speaker index 211 to avatar 224, wherein avatar 224 is the avatar representing speaker index 211. In the depicted embodiment, avatar 226 is the avatar representing speaker index 240 and avatar 228 is the avatar representing speaker index 250. In various embodiments, component 150 assigns each faux utterance to a corresponding speaker index until all generated faux utterances are assigned.

In the depicted embodiment, component 150 converts, using speech synthesis technology, each assigned faux utterance 222 into faux speech 230 based on the recorded speech speed of its corresponding real utterance 201. Further, in the depicted embodiment, component 150 manipulates the position and motion of the mouth of avatar 224 so that the facial and mouth movement of avatar 224 mimics and matches faux speech 230 so that faux speech 230 is the audio output that is receivable and/or perceivable by external user 206. In various embodiments component 150 manipulates the position and motion of the mouth and face of a user's virtual avatar to match faux utterance 222 as a sound source position to output faux speech 230 so that external user 206 perceives (e.g., hears) faux speech 230. In various embodiments, based on the synthesized faux speech (e.g., faux speech 230), component 150 utilizes voice-based 3D face reconstruction technology to drive the neutral 3D face model of the member who has been assigned the faux speech (e.g., avatar 224); so that the dynamic changes of the lip region on that member's 3D face, displayed within the field of view of the external user's VR or AR glasses, match the output of faux speech 230 from user's avatar (e.g., avatar 224).

FIG. 3 is a functional block diagram illustrating a distributed data processing environment in accordance with one embodiment of the present invention. The term “distributed” as used in this specification describes a computer system that includes multiple, physically distinct devices that operate together as a single computer system. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims. The distributed data processing environment may include client computer 101, and remote server 104 interconnected via WAN 102.

In the depicted embodiment, component 150 determines chat progress by filling historical chat content 302 (e.g., stored conversation 204 of chat group 202 from FIG. 2 above) into prompt template 304 to generate and obtain prompt 306. For example, prompt template 304 is defined to be “For the chat content [historical chat content], generate as many utterances following that conversation as possible, wherein the topic of that conversation and all sub-topics should be thoroughly discussed by [speaker count] speakers until that topic and sub-topics end.” In this example, component 150 fills in historical chat content and speaker count of prompt template 304.

In the depicted embodiment, component 150 utilizes Monte Carlo search and feeds prompt 306 into LLM 218 N times to obtain total N generated future conversations that follow the historical real chat content, respectively. In various embodiments, component 150 generates, through LLM 218 and prompt 306 future conversation set 308 and obtains the respective utterance numbers of total N generated future conversations from future conversation set 308, as shown in the depicted embodiment. Component 150 may calculate average utterance number based on the N obtained utterance numbers, as the final utterance number of a future conversation corresponding to the historical real chat content. The chat progress of the current topic may be represented by the ratio of historical-utterance number (obtained from the historical real chat content) to future-utterance number (i.e., the final utterance number mentioned above), and is visually presented by the borderline of an experience annulus.

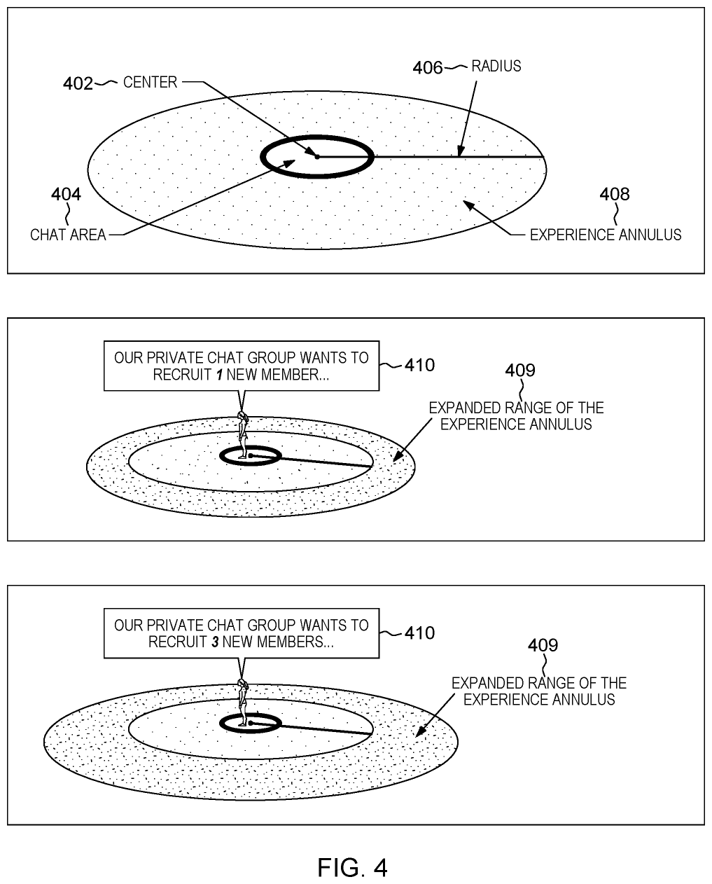

FIG. 4 is a functional block diagram illustrating a distributed data processing environment in accordance with one embodiment of the present invention. The term “distributed” as used in this specification describes a computer system that includes multiple, physically distinct devices that operate together as a single computer system. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims. The distributed data processing environment may include client computer 101, and remote server 104 interconnected via WAN 102.

The depicted embodiment provides a description of the utilization of the annulus range associated with a user's experience. In the depicted embodiment, component 150 takes the geometric center of a chat area 404 as the center 402, and the farthest distance that the maximum voice volume of the members standing in the chat area can propagate (sound is simulated to be attenuated) as the radius 406, to determine the minimum range of experience annulus 408. In the depicted embodiment, responsive to determining the number of new members to be added 410 to the private chat group, component 150 dynamically expands the range of the experience annulus 409 that corresponds with the identified number of new members. In various embodiments, component 150 expands experience annulus 408 by expanding radius 406. For example, L indicates a predefined length (e.g., 0.5 virtual meter in 3D virtual environment); N indicates the number of new members to be added; R indicates the increment of the radius 406. Thus, component expands radius 406 by R=L*N. For example, If N=0 (i.e., NO new members to be added), then the radius 406 will not be expanded. However, in a different example, If N=1 (i.e., only one new member to be added), then the radius 406 will increase by 0.5 meter. In another example, If N=2 (i.e., two new members to be added), then the radius 406 will increase by one meter.

In various embodiments, when a private chat group determines the number of new members to be added 410, component 150 dynamically expands the range of experience annulus 409 (e.g., radius) based on the identified number of new members to be added. For example, if private chat group determines the number of new members to be added 410 is one member, then component 150 dynamically expands the range of experience annulus 409 by a factor of one. In another example, if private chat group determines the number of new members to be added 410 is three members, then component 150 dynamically expands the range of experience annulus 409 by a factor of three. In various embodiments, the increment (of the experience annulus) in the radial direction with the geometric center of the chat area as the center has a linear relationship with the number of new members to be included, wherein the dynamical expansion of experience annulus creates an efficient experience for external users to perceive the externally perceivable features of the private chat group and increases the probability of including new members of the private chat group.

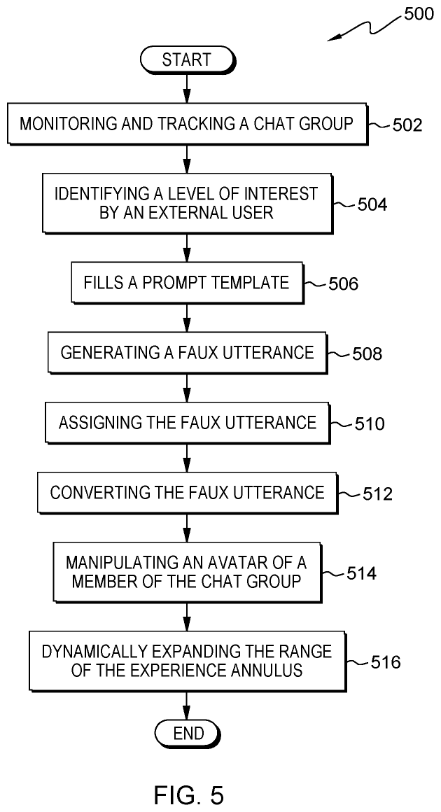

FIG. 5 illustrates operational steps of component 150, generally designated 500, in communication with client computer 101, remote server 104, private cloud 106, EUD 103, and/or public cloud 105, within distributed data processing environment 100, for generating and presenting externally perceivable features associated with a group chat in a virtual environment, in accordance with an embodiment of the present invention. FIG. 5 provides an illustration of one implementation and does not imply any limitations with regard to the environments in which different embodiments may be implemented. Many modifications to the depicted environment may be made by those skilled in the art without departing from the scope of the invention as recited by the claims.

In step 502, component 150 monitors and tracks, in real time, a conversation being held within a chat group (also referred to as a real conversation or “conversation”). In various embodiments, component 150 may track at least a portion of the conversation in real time and identify and extract a predetermined number of utterances, and order of the utterances and speaker index of each utterance, wherein each identified verbal or expressed utterance is converted to text via a speech-to-text system or image recognition system, respectively. In various embodiments, component 150 utilizes the converted text from the verbal utterances to analyze and determine current topics, word count per utterance, speech speed per utterance (slow/normal/fast), and language per utterance. Component 150 may record and store the captured date from the monitored and tracked conversation to a database.

In step 504, component 150 identifies a level of interest for an external user, wherein the level of interest is based on one or more predetermined metrics and weights. In various embodiments, component 150 identifies whether the current topic being discussed in the chat group is of interest to an external user (i.e., a user who is not a member of the chat group and is in an experience annulus) based on an analysis of the historic activities, user profile, designated liked topics, and/or any other user data of the external user. In various embodiments, responsive to identifying that external user is interested in the current topic of the chat group, component 150 generates and outputs an utterance that is externally perceivable to the external. In various embodiments, if component 150 identifies that external user is not interested in the conversation or that the chat group is no longer accepting new group members then component 150 randomly generates an alternative topic unrelated to the conversation being had by the chat group (e.g., faux topic) and outputs the randomly generated alternative topic to the external user as an externally hearable topic. In some embodiments, component 150 utilizes the user data associated with external user to identify a topic that the external user is uninterested to facilitate the alternative topic that is output to the external user.

In step 506, component 150 fills a prompt template. In various embodiments, component 150, for the utterance(s) of the conversation, fills a prompt template based on the recorded order of each utterance in the conversation. Component 150 may utilize recorded speaker index, word count, identified language from recorded conversation data and externally hearable topic to fill the prompt template. The prompt template may be utilized to generate and output a prompt. For example, the recorded conversation data, from the monitored and tracked chat group conversation, comprises a speaker index, a word count, and an identified or established language, wherein component 150 has identified the word count of speaker index to be 35 words, and component 150 has identified the language of speaker index to be English. Continuing the example in the depicted embodiment, prompt template 214 comprises a predetermine number of template parameters, wherein the predetermined number of template parameters comprise, but are not limited to, externally hearable topics, visible topics, word count, speaker index, and language. Speaker index may correspond to a user identification number, or a numerical metric used to index and catalog utterances of a user within a conversation with other users.

In step 508, component 150 generates a faux utterance. In the depicted embodiment, component 150 feeds the generated prompt into a LLM to generate a faux utterance to simulate a faux conversation, wherein the faux utterance 222 corresponds to a real utterance from the monitored and tracked conversation (e.g., real utterances). In various embodiments, the faux utterance is associated with an externally hearable topic and comprises the same word count, language, and speaker index as the corresponding real utterance. In various embodiments, the faux conversation is composed of a plurality of faux utterances that are generated in sequence that correspond to a plurality of real utterances in the conversation. In some embodiments, the corresponding faux utterances equal the same number of real utterances.

In step 510, component 150 assigns the faux utterance. In various embodiments, component 150 assigns the faux utterance to a specific member of the private chat group based on speaker index, wherein the faux utterance is assigned to the user whose real utterance utilized to generate the faux utterance. In various embodiments, component 150 assigns the faux utterance associated with the speaker index to the avatar associated with the speaker index. In various embodiments, component 150 assigns each faux utterance to a corresponding speaker index until all generated faux utterances are assigned.

In step 512 component 150 converts the faux utterance. In various embodiments, component 150 converts, using speech synthesis technology, each assigned faux utterance into faux speech based on the recorded speech speed of its corresponding real utterance and other data from monitored and tracked conversation.

In step 514 component 150 manipulates an avatar of a member of the chat group. In various embodiments, component 150 manipulates the position and physical motion of an avatar. For example, component 150 manipulates the motion of the mouth of avatar so that the facial and mouth movement of the avatar mimics and matches the generated and output faux speech that the avatar appears to be speaking the faux speech when perceived by the external user, wherein the faux speech is an audio output that is receivable and/or perceivable by the external user. In various embodiments component 150 manipulates the position and motion of the mouth and face of a user's virtual avatar to match the faux utterance as a sound source position to output the faux speech so that the external user perceives (e.g., hears) faux speech. In various embodiments, based on the synthesized faux speech component 150 utilizes voice-based 3D face reconstruction technology to drive the neutral 3D face model of the avatar of the member who has been assigned the faux speech; so that the dynamic changes of the lip region on that member's 3D face, displayed within the field of view of the external user's VR or AR glasses, match the output of the faux speech from user's avatar.

In step 516, component 150 dynamically expands the range (e.g., radius) of the experience annulus. In various embodiments, component 150 takes the geometric center of the chat area as the center, and the farthest distance that the maximum voice volume of the members standing in the chat area can propagate (sound is simulated to be attenuated) as the radius, to determine the minimum range of the experience annulus. In various embodiments, responsive to determining the number of new members to be added to the private chat group, component 150 dynamically expands the range of the experience annulus by an amount that corresponds with the identified number of new members to be added. In various embodiments, when a private chat group determines the number of new members to be added, component 150 dynamically expands the range of experience annulus (e.g., radius) based on the identified number of new members to be added.

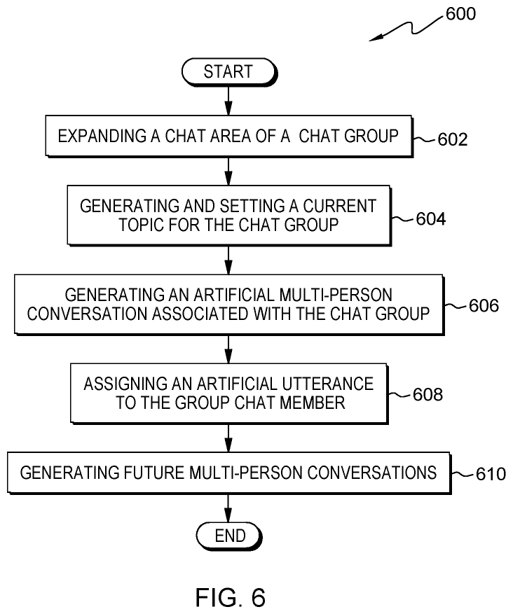

FIG. 6 illustrates operational steps of component 150, generally designated 200, in communication with client computer 101, remote server 104, private cloud 106, EUD 103, and/or public cloud 105, within distributed data processing environment 100, for generating and presenting externally perceivable features associated with a group chat in a virtual environment, in accordance with an embodiment of the present invention. FIG. 6 provides an illustration of one implementation and does not imply any limitations with regard to the environments in which different embodiments may be implemented. Many modifications to the depicted environment may be made by those skilled in the art without departing from the scope of the invention as recited by the claims.

In step 602, component 150 expands the chat area of a private chat group. In various embodiments, component 150 expands chat area of a private chat group to form an experience annulus according to the farthest distance that a maximum voice volume of private-chat-group members can propagate and increasing a range of the experience annulus dynamically according to the number of new members to be added.

In step 604, component 150 generates and sets a current topic of the private chat group. In various embodiments, component 150 generates and sets a current topic of the private chat group or randomly generates a topic as an external user's externally hearable topic based on the analysis of whether the external user is interested in the current topic.

In step 606, component 150 generates a faux multi-person conversation associated with the externally hearable topic. In various embodiments, component 150 generates a faux multi-person conversation associated with the externally hearable topic, by using large language model, that corresponds to a real conversation made by the private chat group, wherein the faux multi-person conversation is a collection of generated faux utterances that correspond with real utterances from the private chat group. In various embodiments, each faux utterance has the same word count, speech speed, language, speaker index as its corresponding real utterance, and wherein the order of speakers uttering all faux utterances in sequence are the same as the real conversation.

In step 608, component 150 assigns each faux utterance to a private chat group member. In various embodiments, component 150 assigns each faux utterance, according to speaker index, to a private chat group member in sequence, and then uses that member's virtual avatar to present the assigned faux utterance to a user in the experience annulus aurally and visually.

In step 610, component 150 generates future multi-person conversations. In various embodiments, component 150 generates future multi-person conversations N times based on a historical real conversation, by using large language model, to obtain a chat progress composed of the numbers of historical and generated future utterances.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
expanding a chat area of a chat group to form an experience annulus according to predetermined distance that a voice volume of private-chat-group member can propagate;
responsive to identifying an external user is interested in the chat group, generating and setting a current topic representing a conversation in the chat group as an externally hearable topic that is perceivable by the external user;
generating a faux multi-person conversation associated with the externally hearable topic that corresponds to a real conversation made by members in the chat group, wherein the faux multi-person conversation is a collection of generated faux utterances that correspond with real utterances from the chat group;
assigning the faux utterances to chat group members based on a corresponding speaker index; and
utilizing one or more corresponding avatars of the chat group members to present the faux utterances to the external user.

2. The computer-implemented method of claim 1, wherein the utilized one or more corresponding avatars are physically manipulated to present the faux utterances.

3. The computer-implemented method of claim 1, further comprising:
monitoring and tracking, in real time, at least a portion of the conversation being held within the chat group; and
identifying and extracting a predetermined number of utterances, order of the utterances, and speaker index of each utterance from the conversation, wherein identified verbal or expressed utterances are converted to text via a speech-to-text system or image recognition system, respectively.

4. The computer-implemented method of claim 3, further comprising:
identifying the external user is interested in the current topic being discussed in the chat group based on an analysis of the historic activities, user profile, and designated liked topics;
responsive to identifying that external user is interested in the current topic of the chat group, generating and outputting an utterance that is perceivable to the external user.

5. The computer-implemented method of claim 3, further comprising:
responsive to identifying that the external user is not interested in the conversation or that the chat group is no longer accepting new group members, randomly generating an alternative topic unrelated to the conversation being had by the chat group based on user data associated with external user to identify a topic that the external user is uninterested to facilitate the alternative topic; and
outputting the randomly generated alternative topic to the external user as an externally hearable topic.

6. The computer-implemented method of claim 4, further comprising:
filling a prompt template based on the recorded order of each utterance in the conversation, wherein the recorded speaker index, the word count, the identified language, and the externally hearable topic are utilized to fill the prompt template; and
utilizing the prompt template to generate and output a prompt.

7. The computer-implemented method of claim 6, further comprising:
generating a faux utterance to simulate a faux conversation based on the generated prompt, wherein the faux utterance corresponds to a real utterance from the monitored and tracked conversation and comprises the same word count, language, and speaker index as the corresponding real utterance.

8. A computer system comprising:
one or more computer processors;
one or more computer readable storage devices;
program instructions stored on the one or more computer readable storage devices for execution by at least one of the one or more computer processors, the stored program instructions comprising:
program instructions to expand a chat area of a chat group to form an experience annulus according to predetermined distance that a voice volume of private-chat-group member can propagate;
responsive to identifying an external user is interested in the chat group, program instructions to generate and set a current topic representing a conversation in the chat group as an externally hearable topic that is perceivable by the external user;
program instructions to generate a faux multi-person conversation associated with the externally hearable topic that corresponds to a real conversation made by members in the chat group, wherein the faux multi-person conversation is a collection of generated faux utterances that correspond with real utterances from the chat group;
program instructions to assign the faux utterances to chat group members based on a corresponding speaker index; and
program instructions to utilize one or more corresponding avatars of the chat group members to present the faux utterances to the external user.

9. The computer system of claim 8, wherein the utilized one or more corresponding avatars are physically manipulated to present the faux utterances.

10. The computer system of claim 8, further comprising:
program instructions to monitor and track, in real time, at least a portion of the conversation being held within the chat group; and
program instructions to identify and extract a predetermined number of utterances, order of the utterances, and speaker index of each utterance from the conversation, wherein identified verbal or expressed utterances are converted to text via a speech-to-text system or image recognition system, respectively.

11. The computer system of claim 10, further comprising:
program instructions to identify the external user is interested in the current topic being discussed in the chat group based on an analysis of the historic activities, user profile, and designated liked topics;
responsive to identifying that external user is interested in the current topic of the chat group, program instructions to generate and output an utterance that is perceivable to the external user.

12. The computer system of claim 10, further comprising:
responsive to identifying that the external user is not interested in the conversation or that the chat group is no longer accepting new group members, program instructions to randomly generate an alternative topic unrelated to the conversation being had by the chat group based on user data associated with external user to identify a topic that the external user is uninterested to facilitate the alternative topic; and
program instructions to output the randomly generated alternative topic to the external user as an externally hearable topic.

13. The computer system of claim 11, further comprising:
program instructions to fill a prompt template based on the recorded order of each utterance in the conversation, wherein the recorded speaker index, the word count, the identified language, and the externally hearable topic are utilized to fill the prompt template; and
program instructions to utilize the prompt template to generate and output a prompt.

14. The computer system of claim 13, further comprising:
program instructions to generate a faux utterance to simulate a faux conversation based on the generated prompt, wherein the faux utterance corresponds to a real utterance from the monitored and tracked conversation and comprises the same word count, language, and speaker index as the corresponding real utterance.

15. A computer program product comprising:
one or more computer readable storage devices and program instructions stored on the one or more computer readable storage devices, the stored program instructions comprising:
program instructions to expand a chat area of a chat group to form an experience annulus according to predetermined distance that a voice volume of private-chat-group member can propagate;
responsive to identifying an external user is interested in the chat group, program instructions to generate and set a current topic representing a conversation in the chat group as an externally hearable topic that is perceivable by the external user;
program instructions to generate a faux multi-person conversation associated with the externally hearable topic that corresponds to a real conversation made by members in the chat group, wherein the faux multi-person conversation is a collection of generated faux utterances that correspond with real utterances from the chat group;
program instructions to assign the faux utterances to chat group members based on a corresponding speaker index; and
program instructions to utilize one or more corresponding avatars of the chat group members to present the faux utterances to the external user.

16. The computer program product of claim 15, wherein the utilized one or more corresponding avatars are physically manipulated to present the faux utterances.

17. The computer program product of claim 15, further comprising:
program instructions to monitor and track, in real time, at least a portion of the conversation being held within the chat group; and
program instructions to identify and extract a predetermined number of utterances, order of the utterances, and speaker index of each utterance from the conversation, wherein identified verbal or expressed utterances are converted to text via a speech-to-text system or image recognition system;
program instructions to identify the external user is interested in the current topic being discussed in the chat group based on an analysis of the historic activities, user profile, and designated liked topics; and
responsive to identifying that external user is interested in the current topic of the chat group, program instructions to generate and output an utterance that is perceivable to the external user.

18. The computer program product of claim 17, further comprising:
responsive to identifying that the external user is not interested in the conversation or that the chat group is no longer accepting new group members, program instructions to randomly generate an alternative topic unrelated to the conversation being had by the chat group based on user data associated with external user to identify a topic that the external user is uninterested to facilitate the alternative topic; and
program instructions to output the randomly generated alternative topic to the external user as an externally hearable topic.

19. The computer program product of claim 17, further comprising:
program instructions to fill a prompt template based on the recorded order of each utterance in the conversation, wherein the recorded speaker index, the word count, the identified language, and the externally hearable topic are utilized to fill the prompt template; and
program instructions to utilize the prompt template to generate and output a prompt.

20. The computer program product of claim 19, further comprising:
program instructions to generate a faux utterance to simulate a faux conversation based on the generated prompt, wherein the faux utterance corresponds to a real utterance from the monitored and tracked conversation and comprises the same word count, language, and speaker index as the corresponding real utterance.
